(19) United States
(12) Patent Application Publication
(10) Pub. No.: US 2014/0027101 A1
(43) Pub. Date: Jan. 30, 2014

(54) HEAT EXCHANGER

(71) Applicants: Eric Konkle, Plainfield, IN (US); Loren D. Hoffman, Jamestown, IN (US)

(72) Inventors: Eric Konkle, Plainfield, IN (US); Loren D. Hoffman, Jamestown, IN (US)

(73) Assignee: Carrier Corporation, Farmington, CT (US)

(21) Appl. No.: 14/111,043

(22) PCT Filed: Apr. 11, 2012
(86) PCT No.: PCT/US12/32985

§ 371 Date: Oct. 10, 2013

Related U.S. Application Data
(60) Provisional application No. 61/474,603, filed on Apr. 12, 2011.

(51) Int. Cl. F28F 1/10; B23P 15/26

(52) U.S. Cl. CPC F28F 1/10; B23P 15/26
USPC 165/178; 29/890.047

(57) ABSTRACT

A heat exchanger includes a plurality of fins and a plurality of tubes extending through the plurality of fins. The heat exchanger includes a plurality of return tubes, each return tube connected to tube ends of desired tubes of the plurality of tubes. At least one return tube of the plurality of end tubes is configured such that an inner surface of the at least one return tube is secured to an outer surface of the tube end. A method of assembling a heat exchanger includes inserting a plurality of tubes through a plurality of fins. Desired tubes of the plurality of tubes are connected via a plurality of return tubes. Each return tube connects one or more of the plurality of tubes by inserting a tube end of a tube of the plurality of tubes into a return tube end of the return tube.

### BACKGROUND OF THE INVENTION

The subject matter disclosed herein relates to heat exchangers. More specifically, the subject disclosure relates to construction of heat exchanger coils for tube-fin heat exchangers or the like.

Tube-fin heat exchangers are typically constructed of a plurality of hairpin tubes which pass through holes in a plurality of fins. The hairpin tubes are typically U-shaped to with the open legs of the hairpin protruding through an end fin, or an end sheet of the heat exchanger. A U-shaped return tube is secured to each open leg of the hairpin to connect the hairpin to adjacent hairpins of the heat exchanger.

Before securing the return to the hairpin, the hairpin is expanded to create a mechanical joint with the fins, and each end of the hairpin is expanded into a bell shape to receive the return tube. The expansion and belling operations require that the inside of the hairpin is lubricated, and a residue from the lubricant typically remains in the hairpin after these operations. The return is then inserted into the belled open end of the hairpin and the components are joined by an adhesive between an outer surface of the return and an inner surface of the hairpin. The presence, however, of the lubricant residue in the hairpin interferes with the bonding action of the adhesive, resulting in leaks, so the hairpin must first be thoroughly cleaned before this bonding operation, which increases cost of the heat exchanger. Further, the inner surface of the hairpin may include rifling or other surface enhancements to improve performance of the heat exchanger. The presence of these enhancements also interferes with the bonding process by presenting an uneven surface for the return tube to affix to.

### BRIEF DESCRIPTION OF THE INVENTION

According to one aspect of the invention, a heat exchanger includes a plurality of fins and a plurality of tubes extending through the plurality of fins. The heat exchanger includes a plurality of return tubes, each return tube connected to tube ends of desired tubes of the plurality of tubes. At least one return tube of the plurality of end tubes is configured such that an inner surface of the at least one return tube is secured to an outer surface of the tube end.

According to another aspect of the invention, a method of assembling a heat exchanger includes inserting a plurality of tubes through a plurality of fins. Desired tubes of the plurality of tubes are connected via a plurality of return tubes. Each return tube connects one or more of the plurality of tubes by inserting a tube end of a tube of the plurality of tubes into an return tube end of the return tube.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of an embodiment of a heat exchanger; and

FIG. 2 is a cross-sectional view of another embodiment of a heat exchanger.

The detailed description explains embodiments of the invention, together with advantages and features, by way of example with reference to the drawings.

### DETAILED DESCRIPTION OF THE INVENTION

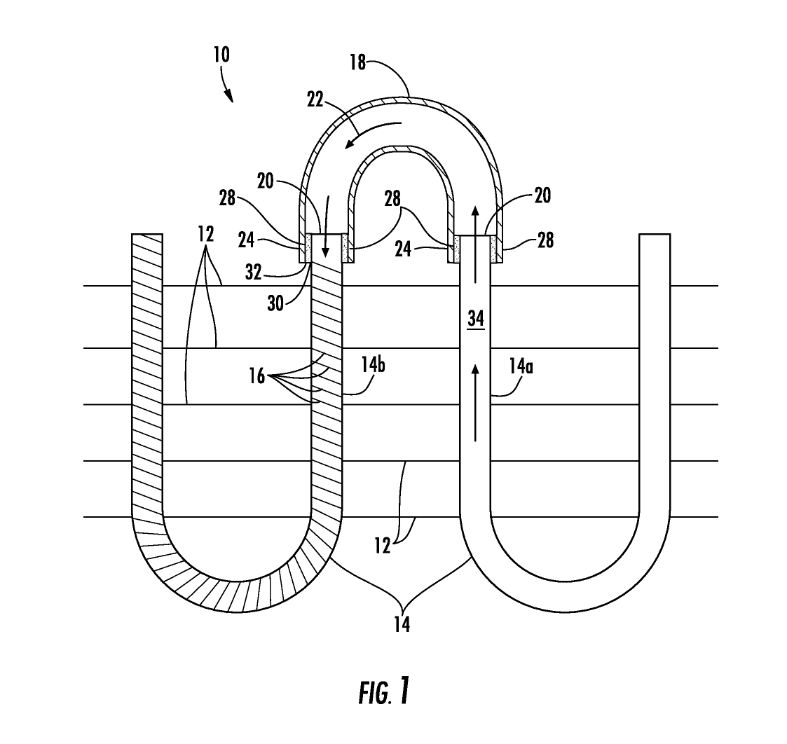

Shown in FIG. 1 is an embodiment of an improved tube-fin heat exchanger 10. The heat exchanger 10 includes a plurality of fins 12, with a plurality of tubes 14 extending therethrough. The tubes 14 may be hairpin, or u-shaped, tubes as shown in FIG. 1, which extend through the fins 12 twice along their length, or may be straight tubes 14, or otherwise configured to extend through the fins 12 only once along their length. In some embodiments, an interior of the tube 14 may include enhancements, for example, grooves 16, to improve heat transfer capability of the tube 14. Though grooves 16 are shown in FIG. 1, it is to be appreciated that other forms of enhancements such as bumps, dimples, etc. are contemplated within the present scope.

A return tube 18 is secured over ends 20 of adjacent tubes 14. The return tube 18 connects a first tube 14a and a second tube 14b to allow a flow of, for example, refrigerant 22 from the first tube 14a through the return tube 18 and into the second tube 14b. In some embodiments, the return tube 18 is substantially U-shaped. Each return tube end 24 has an opening large enough to be located over the tube end 20. The return tube end 24 is secured to the tube end 20 through the utilization of an adhesive layer 28 between an outer tube surface 30 and an inner return tube surface 32. Securing the return tube 18 to the outer tube surface 30 provides better adhesion between the return tube 18 and the tube 14 since the adhesive layer 28 does not contact any lubricant residue present in an interior 34 of the tube 14 from bending or expansion operations. Improved adhesion between the return tube 18 and the tube 14 reduces leakage from the heat exchanger 10 thereby improving heat exchanger 10 performance.

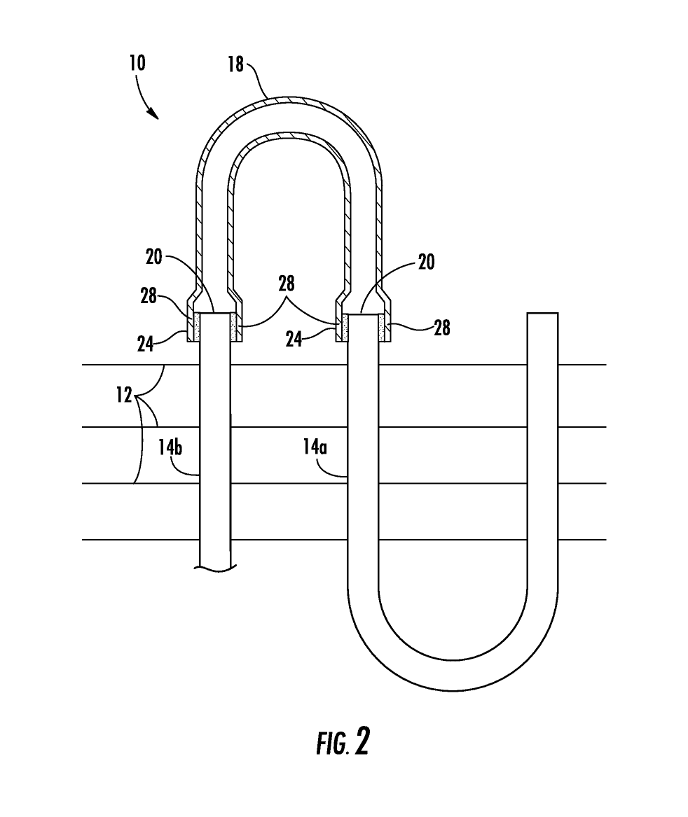

Referring now to FIG. 2, in some embodiments, the return tube ends 24 may be expanded, or belled, to increase a size of the opening to allow for placement over the tube end 20. This allows for reduction in cross-sectional size of the remainder of the return tube 18, if so desired.

The tubes 14 and return tubes 18 may be formed from any desired material such as aluminum, copper, steel, stainless steel, or alloys of one or more of the foregoing, plastics or composites. Further, the adhesive layer 28 may be of an anaerobic adhesive or, for example, an epoxy adhesive.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A heat exchanger comprising:
a plurality of fins;
a plurality of tubes extending through the plurality of fins; and
a plurality of return tubes, each return tube connected to tube ends of desired tubes of the plurality of tubes, at least one return tube of the plurality of end tubes configured such that an inner surface of the at least one return tube is secured to an outer surface of the tube end.

2. The heat exchanger of claim 1, wherein the at least one return tube is secured to the tube end via an adhesive layer disposed between the inner surface and the tube end.

3. The heat exchanger of claim 2, wherein the adhesive layer comprises one of an anaerobic adhesive or an epoxy adhesive.

4. The heat exchanger of claim 1 wherein the at least one return tube has a belled-shape at a return tube end.

5. The heat exchanger of claim 1, wherein at least one return tube of the plurality of return tubes is substantially U-shaped.

6. The heat exchanger of claim 1, wherein at least one tube of the plurality of tubes is substantially U-shaped.

7. The heat exchanger of claim 1, wherein one or more of the plurality of tubes and the plurality of return tubes are formed from one of an aluminum, a copper, a steel, a stainless steel, a plastic or a composite material.

8. A method of assembling a heat exchanger comprising:
inserting a plurality of tubes through a plurality of fins; and
connecting desired tubes of the plurality of tubes via a plurality of return tubes, each return tube connecting to one or more of the plurality of tubes by inserting a tube end of a tube of the plurality of tubes into an return tube end of the return tube.

9. The method of claim 8, further comprising securing the return tube end to the tube end via an adhesive.

10. The method of claim 9, wherein the adhesive comprises one of an anaerobic adhesive or an epoxy adhesive.

11. The method of claim 8, further comprising expanding the return tube end before insertion of the tube end into the return tube end.

12. The method of claim 8, wherein at least one tube of the plurality of tubes passes through the plurality of fins more than once.
